(19) United States
(12) Patent Application Publication
(10) Pub. No.: US 2007/0078235 A1
(43) Pub. Date: Apr. 5, 2007

(54) Glycidyl (meth)acrylate powder coating compositions containing caproloactone-derived side chains

(75) Inventors: Szuping Lu, Canton, MI (US); Rahul Holla, Adrian, MI (US)

Correspondence Address: BUCHANAN, INGERSOLL & ROONEY PC, POST OFFICE BOX 1404, ALEXANDRIA, VA, 22313-1404, US

(73) Assignee: ANDERSON DEVELOPMENT CO., Adrian, MI (US)

(21) Appl. No.: 11/606,894

(22) Filed: Dec. 1, 2006

Related U.S. Application Data
(62) Division of application No. 10/602,888, filed on Jun. 25, 2003.

(51) Int. Cl. C08L 63/00; C08F 224/00

(52) U.S. Cl. 525/523; 526/325; 525/934

(57) ABSTRACT

This invention relates to glycidyl (meth)acrylate based powder coating resins that contain side chains derived from polycaprolactone, powder coatings comprising these resins, and coatings produced from the powder coating compositions. The coatings may be clear coats. The glycidyl (meth)acrylate based powder coating resins of the present invention comprise (a) a glycidyl (meth)acrylate monomer, (b) a caprolactone (meth)acrylate monomer, and optionally (c) an ethylenically unsaturated monomer other than the monomers of (a) or (b).

This application is a divisional of application Ser. No. 10/602,888, filed on Jun. 25, 2003, the entire content of which is hereby incorporated by reference.

### FIELD OF THE INVENTION

The present invention relates to a glycidyl (meth)acrylate based powder coating resin that contains side chains derived from caprolactone. The glycidyl (meth)acrylate resin containing side chains derived from caprolactone may be used in powder coating compositions.

### BACKGROUND OF INVENTION

Powder coatings have been developed since the 1970s. Powder coatings are known to be environmentally friendly since they contain no solvents, which must be evaporated. In recent years, there has been tremendous improvement in the technology related to powder coatings, including the resins, additives, and equipment. Due to their environmentally friendly nature and the developments in powder coating technology, the use of powder coatings has grown rapidly worldwide.

One example of a powder coating system is the glycidyl (meth)acrylate based powder coating (known as GMA powder coating). GMA based powder coatings have been used for 30 years since what is believed to be the first patent related to GMA base powder coatings issued in 1973 (U.S. Pat. No. 3,752,870). The GMA powder coating system has gained a reputation for good smoothness, crystal clarity, chemical resistance, high gloss, and excellent outdoor durability. In fact, to date the GMA powder coating is the only powder coating system that has been selected for automotive full-body clear topcoat application. It also has been widely used in aluminum wheel coating, outdoor furniture, garden equipment, light fixtures, and certain industrial applications where extended weatherability is required.

Despite the significant advantages of GMA powder coatings, problems exist with the GMA powder coating system. These problems have prevented GMA powder coatings from becoming widely accepted for many paint makers and end users in the powder coating industry. The problems that have prevented wide acceptance of GMA powder coatings include those related to the following properties of the GMA powder coating:

1) The GMA powder coating can severely contaminate other powder coating system (especially polyester powder coatings) due to poor compatibility. As a result of the poor compatibility, massive cratering results if the GMA powder coating is used along with another powder coating system in a single location (or sharing the same facility).

2) GMA resins have low pigment dispersion properties.

3) GMA powder coatings have less flexibility compared to other powder coating systems.

4) GMA powder coatings exhibit a lack of powder to powder recoatability. This problem has slowed down acceptance of GMA powder coating for automotive clearcoat application.

The typical approach to reducing coating cratering caused by cross-contamination is to include particular flow control agents as one of the coating additives. The flow control agents reduce the powder surface tension and make the powder coating less subject to foreign contamination. U.S. Pat. No. 6,013,733 describes a comprehensive study on the use of flow control agents in this manner.

One approach to improving the pigmentation properties is to introduce more polar functional components into the coating composition. U.S. Pat. Nos. 4,988,767, 5,098,955, and 5,202,382 describe such an approach.

The approaches to improving the flexibility (or impact resistance) are described in several patents. For example, U.S. Pat. No. 6,359,067 describes using an elastomer as impact modifier. U.S. Pat. No. 6,479,588 describes using a polyamide to graft into the resin backbone. U.S. Pat. No. 5,596,043 describes using a mixture with polyurethane. U.S. Pat. No. 6,025,030 describes introducing carboxylic functional acrylic into the coating formulation.

However, typical approaches to improve the properties of GMA powder coating improve only one specific property at a time, and the improvements are very limited.

Therefore, it is desired to make a GMA powder coating with improvements in all of the properties to provide wider acceptance of GMA powder coatings.

### SUMMARY OF THE INVENTION

In one aspect, the present invention relates to a curable powder coating composition. The curable powder coating composition comprises (a) a glycidyl(meth)acrylate based resin and (b) a curing agent. The glycidyl(meth)acrylate based resin is formed by copolymerizing (i) a glycidyl (meth)acrylate monomer of the following formula I 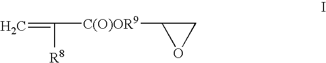
wherein R⁸ is H or lower alkyl and R⁹ is a branched or unbranched alkyl group containing from 1 to 4 carbon atoms, (ii) a caprolactone (meth)acrylate monomer of the following formula II 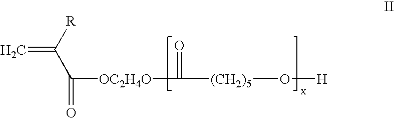
wherein x is 1 to 5 and R is hydrogen or lower alkyl; and optionally (iii) an ethylenically unsaturated monomer other than the monomers of (i) and (ii).

In another aspect, the invention relates to a glycidyl (meth)acrylate based resin for powder coating. The glycidyl (meth)acrylate based resin for powder coating comprises (a) a glycidyl (meth)acrylate monomer of formula I as defined above; (b) a caprolactone (meth)acrylate monomer of formula II as defined above; and optionally (c) an ethylenically unsaturated monomer other than the monomer of (a) or (b). Preferably the glycidyl (meth)acrylate monomer of formula I is glycidyl (meth)acrylate (R⁸ is methyl and R⁹ is methylene).

In a further aspect, the invention relates to a process for producing a glycidyl (meth)acrylate based resin. The process comprises polymerizing in an organic solvent copolymerization medium a mixture of monomers comprising glycidyl (meth)acrylate, a caprolactone (meth)acrylate monomer of the following formula II: 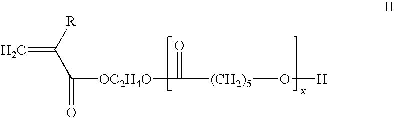
wherein x is 1 to 5 and R is hydrogen or lower alkyl, and an ethylenically unsaturated monomer other than glycidyl (meth)acrylate and caprolactone (meth)acrylate monomer, in the presence of a polymerization initiator to produce a glycidyl (meth)acrylate based resin having side chains derived from caprolactone wherein the resin has a weight average molecular weight of 3,000 to 20,000, a measured glass transition temperature of 35 to 70° C., and epoxy equivalent weight of 200 to 1450. Preferably the ethylenically unsaturated monomer is methyl (meth)acrylate, styrene, or mixtures thereof.

In yet a further aspect, the invention relates to a process for producing a thermoset powder coating. The process comprises synthesizing a glycidyl (meth)acrylate based resin by copolymerizing (i) a glycidyl (meth)acrylate monomer of the following formula I 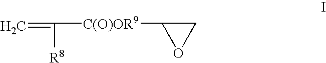
wherein R⁸ is H or a lower alkyl and R⁹ is a branched or unbranched alkyl group containing from 1 to 4 carbon atoms; (ii) a caprolactone (meth)acrylate monomer of the following formula II 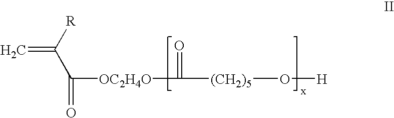
wherein x is 1 to 5 and R is hydrogen or lower alkyl; and optionally (iii) an ethylenically unsaturated monomer other than the monomers of (i) and (ii). The glycidyl (meth)acrylate based resin is mixed with a curing agent to provide a thermosetting powder coating composition. The thermosetting powder coating composition is applied to a substrate and cured to provide a thermoset powder coating.

### BRIEF DESCRIPTION OF THE DRAWINGS

FIG. 1 illustrates a wafer on a test panel for testing powder to powder recoatability.

FIG. 2 illustrates the results of a cross contamination test conducted on the comparative coating example CC-1.

FIG. 3 illustrates the results of a cross contamination test conducted on the coating example C1 made with resin R1.

FIG. 4 illustrates the results of a pigment dispersion test conducted at a thickness of 2 mil on the comparative coating example CC-2.

FIG. 5 illustrates the results of a pigment dispersion test conducted at a thickness of 2 mil on the coating example C-2 made with resin R1.

FIG. 6 illustrates the results of a pigment dispersion test conducted at a thickness of 1 mil on the comparative coating example CC-2.

FIG. 7 illustrates the results of a pigment dispersion test conducted at a thickness of 1 mil on the coating example C-2 made with resin R1.

### DETAILED DESCRIPTION OF THE INVENTION

### Definitions

Unless otherwise stated, the following terms used in the specification and claims have the meanings given below:

“Alkyl” means a linear saturated monovalent hydrocarbon group of one to eight carbon atoms or a branched saturated monovalent hydrocarbon group of three to eight carbon atoms. Examples of alkyl groups include, but are not limited to, groups such as methyl, ethyl, n-propyl, isopropyl, n-butyl, isobutyl, sec-butyl, t-butyl, n-pentyl, and the like.

“Lower alkyl” means an alkyl group as defined above having one to four carbon atoms. Examples of lower alkyl groups include, but are not limited to, groups such as methyl, ethyl, n-propyl, isopropyl, n-butyl, and the like.

According to the present invention, glycidyl (meth)acrylate based resins for powder coating are synthesized by copolymerizing (a) a glycidyl (meth)acrylate monomer, (b) a caprolactone (meth)acrylate monomer, and optionally (c) an ethylenically unsaturated monomer other than the monomers of (a) or (b). These glycidyl (meth)acrylate based resins may be used in powder coating compositions.

The caprolactone (meth)acrylate monomer employed in this invention has the following formula (II): 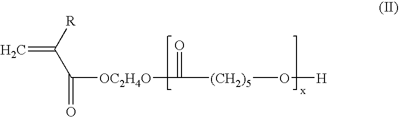
wherein x is 1 to 5 and R is hydrogen or lower alkyl. The caprolactone meth(acrylate) monomer may comprise mixtures of monomers of formula II.

The caprolactone (meth)acrylate monomer can be obtained commercially from the Dow Chemical Company (Midland, Mich.) as Tone M-100™, Tone M-101™, and Tone M-201™, Sartomer (Exton, Pa.) as SR-495™, and Daicel Chemical Industries (Teppo-cho, Sakai-shi, Osaka, JAPAN) as Placcel FA and FM series of monomers. In the alternative, the caprolactone (meth)acrylate monomer can be prepared under reaction conditions known to those of skill in the art.

Please insert a brief statement of how to synthesize caprolactone (meth)acrylate monomers (starting materials, conditions, etc) or cite a reference.

The glycidyl (meth)acrylate based resin of the present invention comprises the caprolactone (meth)acrylate monomer in an amount of 2-30% by weight, and more preferably 5-20% by weight, based on the total weight of the resin. The amount of the caprolactone (meth)acrylate monomer in the resin can be varied, and certain properties of the resin may improve as increasing amounts of this monomer are used. Although increasing amounts of this monomer in the resin composition may enhance certain properties, increasing amounts may depress the resin T_{g}. It is desired that the resin T_{g} is greater than 35° C., preferably greater than 40° C., because if the resin measured T_{g} is lower than 35° C., sintering can easily occur during storage. Therefore, the amount of caprolactone (meth)acrylate monomer used in the glycidyl (meth)acrylate based resin is balanced to maintain the resin T_{g} greater than 35° C. Preferably the resin compositions have a T_{g} of 35° C. to 70° C.

The glycidyl (meth)acrylate based resin for powder coating of the present invention also comprises a glycidyl (meth)acrylate monomer of the following formula I 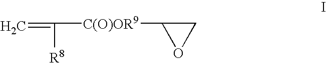
wherein R⁸ is H or a lower alkyl and R⁹ is a branched or unbranched alkyl group containing from 1 to 4 carbon atoms. Illustrative compounds within the definition of formula (I) are glycidyl acrylate, glycidyl (meth)acrylate, and 1,2-epoxybutylacrylate. The glycidyl (meth)acrylate monomer may comprise a mixture of monomers of formula I. Preferably, the glycidyl (meth)acrylate monomer of formula I is glycidyl (meth)acrylate (R⁸ is methyl and R⁹ is methylene).

The glycidyl (meth)acrylate monomer, in particular glycidyl (meth)acrylate, wherein R⁸ is methyl and R⁹ is methylene (CAS # 106-91-2), and glycidyl acrylate, wherein R⁸ is hydrogen and R⁹ is methylene, (CAS # 106-90-1), can be obtained commercially from the Dow Chemical Company (Midland, Mich.), NOF Corporation (Ebisu, Shiboya-ku, Tokyo), Mitsubishi Rayon Co. (Konan, Minato-ku, Tokyo), Mitsubishi Gas Chemical Co. (Marunaouchi, Chiyodako, Tokyo), and Easton Chemical Co. (Calvert City, Ky.). In the alternative, the glycidyl (meth)acrylate monomer can be prepared under reaction conditions known to those of skill in the art.

The glycidyl (meth)acrylate based resin of the present invention comprises the glycidyl (meth)acrylate monomer in an amount of 10 to 80% by weight, and more preferably 20 to 60% by weight, based on the total weight of the resin. The amount of the glycidyl (meth)acrylate monomer in the resin can be varied, and as described above certain properties may improve with decreasing amounts of this monomer used with increasing amounts of the caprolactone (meth)acrylate monomer. Therefore, the amounts of glycidyl (meth)acrylate monomer and caprolactone (meth)acrylate monomer used in the resin compositions are balanced to maintain the product resin T_{g} greater than 35° C., preferably greater than 40° C. Preferably the resin composition has a T_{g} of 35° C. to 70° C.

In addition to the glycidyl (meth)acrylate monomer and the caprolactone (meth)acrylate monomer, the glycidyl (meth)acrylate based resin, and thus the powder coating composition comprising the resin, may optionally comprise an ethylenically unsaturated monomer other than the glycidyl (meth)acrylate monomer and the caprolactone (meth)acrylate monomer. The ethylenically unsaturated monomer may comprise a mixture of monomers. This ethylenically unsaturated monomer may be selected from alkyl esters of acrylic acid monomers, alkyl esters of (meth)acrylic acid monomers, vinyl monomers, acrylonitriles, acrylamides, hydroxyalkylesters of acrylic acid and methacrylic acid, dialkyl esters of unsaturated dibasic acids, and mixtures thereof.

By way of example, the alkyl esters of acrylic acid monomers and the alkyl esters of (meth)acrylic acid monomers may be selected from methyl acrylate, ethyl acrylate, n-butyl acrylate, isobutyl acrylate, 2-ethylhexyl acrylate, cyclohexyl acrylate, isobornylacrylate, methyl (meth)acrylate, ethyl (meth)acrylate, n-butyl (meth)acrylate, isobutyl (meth)acrylate, 2-ethylhexyl (meth)acrylate, lauryl (meth)acrylate, tridecyl (meth)acrylate, stearyl (meth)acrylate, cyclohexyl (meth)acrylate, isobornyl (meth)acrylate, and mixtures thereof. Further by way of example, the vinyl monomers may be selected from styrene, α-methyl styrene, α-ethylstyrene, vinyl toluene, divinyl benzene, vinyl chloride, vinylidene chloride, vinyl acetate, vinyl propionate, and mixtures thereof. The acrylonitriles include, for example, acrylonitrile, and methacrylonitrile, and the acrylamindes include, for example, acrylamide and dimethylacrylamide. The hydroxyalkylesters of acrylic and methacrylic acid include, for example, β-hydroxyethyl acrylate, β-hydroxypropyl (meth)acrylate, hydroxylpropyl methacrylate, and mixtures thereof. These ethylenically unsaturated monomers of the present invention are as described in U.S. Pat. Nos. 4,042,645 and 5,270,391, the contents of which are herein incorporated by reference in their entirety.

The glycidyl (meth)acrylate based resin of the present invention comprises the other ethylenically unsaturated monomers in an amount of 0 to 88% by weight, and more preferably 40 to 80% by weight, based on the total weight of the resin. The amount of the other ethylenically unsaturated monomers in the resin can be varied to provide a powder coating with desired properties.

The glycidyl (meth)acrylate based resin of the present invention comprises (a) a glycidyl (meth)acrylate monomer of formula I, (b) a caprolactone (meth)acrylate monomer of formula II, and optionally (c) an ethylenically unsaturated monomer other than the monomers of (a) or (b). The glycidyl (meth)acrylate based resin is prepared by copolymerizing the above monomers. The copolymerization of the monomers to prepare the resin can be conducted under reaction conditions known to those of skill in the art. Illustrative conditions are set forth in U.S. Pat. Nos. 4,042,645, 5,270,391, 5,744,522, and 6,479,588, the contents of which are herein incorporated by reference in their entirety.

For instance, the (a) glycidyl meth(acrylate) monomer of formula I, (b) caprolactone (meth)acrylate monomer of formula II, and optionally (c) the ethylenically unsaturated monomer other than the monomer of (a) or (b) can be copolymerized in an organic solvent polymerization medium in the presence of a polymerization initiator to produce a glycidyl (meth)acrylate based resins having side chains derived from caprolactone. The sequence of addition of the monomers to be copolymerized and initiation of polymerization may be varied so long as a glycidyl (meth)acrylate resin as described above is formed. For instance, all monomers to be copolymerized may be added to a reaction vessel and then polymerization may be initiated. In the alternative, a portion of the monomers may be added to the reaction vessel, and polymerization may be initiated. Within an appropriate amount of time, the remaining monomers may be added; the remaining monomers may be added all at once or in stages so long as a glycidyl (meth)acrylate resin as described above is formed. Preferably, all monomers to be copolymerized are initially added to the reaction vessel and then polymerization is initiated for the complete batch of monomers.

Suitable organic solvents for the copolymerization reaction include, for example, xylene, toluene, butyl acetate, and the like, and mixtures thereof. Suitable polymerization initiators include ones that generate free radicals. Suitable polymerization initiators include, for example, azobisisobutyronitrile, benzoyl peroxide, lauryl peroxide, di-t-butylperoxide, and di-t-amyl peroxide, and the like, and mixtures thereof. The polymerization initiator can be present in an amount of from about 0.1 to 10 weight percent by weight of the total weight of the monomers to be copolymerized, depending on the initiator used and the desired resin molecular weight. The copolymerization reaction is conducted at elevated temperatures, preferably at temperatures of 80 to 170° C., preferably at reflux, for 3 to 6 hours, preferably with continuous addition of the monomer mixture. The copolymerization reaction may be conducted in an inert atmosphere such as under nitrogen or argon.

After polymerization, the reaction mixture is cooled and dried, if necessary, to provide a friable resin. The friable resin may be pulverized to provide a powdered glycidyl (meth)acrylate based resin.

The resulting glycidyl (meth)acrylate based resin of the present invention is a solid copolymer. The resin has a weight average molecular weight of from about 3,000 to about 20,000, preferably from about 4,000 to about 15,000 as determined by gel permeation chromatography relative to polystyrene standards. Higher molecular weights tend to provide copolymers with higher melt viscosities that are less preferable. In this respect, it is desirable to have a glycidyl (meth)acrylate based resin having a melt viscosity of from about 50 to about 700 poise, preferably from about 80 to about 500 poise at 150° C. as determined by an ICI Cone and Plate Viscometer. In addition, the glycidyl (meth)acrylate based resin has a measured glass transition temperature of 35 to 70° C., preferably 40 to 65° C. The glycidyl (meth)acrylate based resin also has an epoxy equivalent weight of 200 to 1450, preferably 250 to 750.

The glycidyl (meth)acrylate based resins containing side chains derived from caprolactone of the present invention may be used in powder coating compositions to create powder coatings with superior properties.

The coating compositions and processes to make powder coatings from the powder coating compositions comprising the glycidyl (meth)acrylate based resins containing side chains derived from caprolactone are the same as for conventional glycidyl (meth)acrylate based powder coatings. Illustrative compositions and conditions are set forth in U.S. Pat. Nos. 5,270,416, 5,407,747, 5,710,214, 5,939,195, 6,077,608, 6,277,917, 6,359,067, and 6,479,588, the contents of which are herein incorporated by reference in their entirety.

The powder coating compositions of the present invention comprise the glycidyl (meth)acrylate based resins as described herein and an appropriate curing agent or curative. Suitable curing agents for the glycidyl (meth)acrylate based resins of the present invention are curing agents that are used for conventional glycidyl (meth)acrylate powder coatings. These curing agents are known to those of skill in the art. Suitable curing agents include polycarboxylic acids, polycarboxylic acid anhydrides, polyisocyanates, and mixtures thereof. The polycarboxylic acids include two or more acid groups per molecule. Anhydrides may be prepared from these polycarboxylic acids. Preferably, the curing agent is a solid dicarboxylic acid. Suitable curing agents include 1,12-dodecanedioic acid (e.g., available from E. I. Dupont de Nemours, Wilmington, Del.) and 1,3,4-butanetricarboxylic acid (e.g., available from Mitsubishi Chemicals, Inc., Tokyo, Japan). Descriptions of suitable curing agents are set forth in U.S. Pat. Nos. 5,270,416, 5,407,747, 6,077,608, 6,277,917, 6,359,067, and 6,479,588, the contents of which are herein incorporated by reference in their entirety.

The curing agent is present in the powder coating composition in an amount to effectively cure the applied powder coating. The amount may vary depending on epoxy equivalent weight of the resin, the composition of the resin, the curing agent used, and the desired properties of the cured coating. Preferably, the curing agent is present in the powder coating composition in an amount ranging from about 7 to about 40% by weight based on the total weight of glycidyl (meth)acrylate based resin, preferably from about 12 to about 35% by weight. As noted above, mixtures of curing agents may also be used.

The powder coating compositions of the present invention comprising the glycidal (meth)acrylate resin and curing agent may also comprise additives suitable for powder coating compositions. Additives typically used in powder coating compositions are known to those of skill in the art. These additives can include pigments, fillers, light stabilizers, and antioxidants. Examples of the additives include curing catalysts, flow regulators, thixotropy regulators, antistatic agents, surface regulators, brighteners, anti-blocking agents, plasticizers, ultraviolet light absorbers, impact modifier, humidity regulators, anti-caking reducers, and degassers or anti-popping agents. All additives are blended in a range that does not substantially adversely affect the properties of the powder coatings comprising the glycidyl (meth)acrylate resins of the present invention. Specifically, these additives may include benzoin (volatiles release agent or anti-popping agent), CGL 1545 hydroxyphenyl triazine ultraviolet absorber (available from Ciba-Geigy Limited, Basel, Switzerland), Modaflow (or Resiflow) flow additives (available from Monsanto Chemical Company, St. Louis, Mo.), tertiary amine or N-alkylimidazole (curing catalysts), fumed silica to reduce caking sold as CAB-O-SIL (available from Cabot Corporation, Billerica, Mass.) and the like.

If color is desired, a sufficient amount of pigment may be added to the powder coating composition to provide the color desired. The amount of pigment used in the powder coating compositions generally is from 1 to 50 percent by weight based on the total weight of the composition. Suitable pigments include, for example, titanium dioxide, ultramarine blue, phthalocyanine blue, phthalocyanine green, carbon black, graphite fibrils, black iron oxide, chromium green oxide, ferric yellow, and quindo red.

The powder coating composition can be prepared by selecting the proper amounts of the components of the composition, including the glycidyl (meth)acrylate resin, curing agent, and optionally additives, and thoroughly premixing the components to form an essentially homogeneous mixture. All components of the powder coating composition can be mixed as powders by a dry-blending process or the components can be mixed by a semi-dry-blending process or melt-blending process. If melt-blended, after all components are appropriately blended, they are cooled, dried if necessary, and then crushed to a powder.

For instance, to prepare a powder coating composition according to the present invention, the components of the powder coating composition (i.e., the glycidyl (meth)acrylate resin, curing agent, and optionally additives) are premixed. Premixing of all components may be achieved by any suitable means. An illustrative small scale mixer is a Vitamixer blender of the Vitamix Corporation in Cleveland, Ohio. The premixed components are then placed in a heated extruder where the mixture is melt mixed and extruded. One type of extruder that can be used is an APV Model 19 PC twin screw extruder with two individually adjustable heating zones with a variable rotation rate that can provide an extrudate in ribbon form from between a pair of chilled pinch rolls. The extruded composition is then crushed into powder form by any suitable means, such as a hammer mill (or a Vitamixer blender for small quantities) and powder passing through a 140 or 170 mesh sieve is collected.

To apply the coating composition to a surface, conventional techniques can be used so as to obtain a smooth, substantially uniform coating. Typically it is desired that the coating have a thickness that is generally from about 1.0 to about 10 mils, preferably from about 2.0 to about 4.0 mils. The powder coating composition can be applied directly to an article or substrate, for example, metal such as steel or aluminum. The powder coating compositions can be applied directly upon bare surfaces or on previously treated surfaces. Preferably, the powder coating of the present invention is a clearcoat for application over or with any basecoat formulation known to those skilled in the art. For instance, a clear coating can be applied to a previously color coated surface to provide a clear coating on the colored surface.

Application of the powder coating of the present invention can be by spraying, and in the case of metal substrates by electostatic spraying, or by the use of a fluidized bed. Spraying equipment is commercially available from manufacturers such as GEMA Volstatic of Indianapolis, Ind. and The Nordson Corp. of Amherst, Ohio. The powder coating can be applied in a single sweep or in several passes to provide a film with the desired thickness after curing.

Curing of the powder coating of the present invention is achieved by heating the coated surface for a time sufficient to cure the composition. Although the specific curing conditions depend on the precise constituents of the composition, including the curing agent and the presence or absence of a curing catalyst, typical curing conditions without the presence of a curing catalyst are from about 15 to about 45 minutes at about 135° C. to 200° C. As an illustration, typical curing conditions for a cured coating of 3 mils (approximately 80 microns) is 30 minutes at 165 ° C.

By following the teachings of the present invention, the cured coating composition exhibits a smooth finish. The powder coating compositions are applied to an appropriate article or substrate and heated for 15 to about 45 minutes at about 135° C. to 200° C. to provide a cured coating on the article or substrate. The cured coatings formed from the powder coating compositions of the present invention exhibit an acceptable 60° gloss as measured by ASTM D523 as described in U.S. Pat. No. 5,436,311.

The cured coatings may exhibit certain advantages over coatings formed from conventional GMA powder coatings. For example, the powder coatings of the present invention may exhibit improved compatibility with polyester powder coating compositions and as such, when contaminated with a polyester powder coating composition, the cured powder coatings may display less cratering than conventional GMA powder coatings. In addition, the powder coatings of the present invention may exhibit improved pigment dispersion in comparison to conventional GMA powder coatings. The powder coatings of the present invention may also exhibit improved flexibility in comparison to conventional GMA powder coatings. Furthermore, the powder coatings of the present invention may exhibit improved powder to powder recoatability in comparison to conventional GMA powder coating. The cured coatings of the present invention may exhibit one or more, or all of these improved properties.

These properties (i.e., cross-contamination (or compatibility), pigment dispersion, flexibility, and recoatability) may be evaluated by the following procedures.

### Cross-contamination

To evaluate cross-contamination, a powder coating of the present invention is used to contaminate a polyester powder coating by blending 0.1 weight % of a powder coating of the present invention with a polyester powder coating. This blending simulates cross-contamination that can occur in a work place using polyester powder coatings if conventional GMA powder coatings are introduced. The contaminated powder coating is cured and the degree of cratering exhibited on the coating is evaluated. The following categories can be used in evaluating the contamination results:

Excellent: 0 to 2 craters per coating panel;

Good: 3 to 5 craters per coating panel;

Fair: 6 to 10 craters per coating panel; and

Severe: greater than 10 craters per coating panel.

### Pigmentation

To evaluate the degree of pigment dispersion, a pigmented powder coating of the present is prepared. A control pigmented powder is prepared by a conventional process for comparison. The powders are dissolved in toluene at 50% concentration. The solution is applied to a Hegman Gage (Hegman Gages are well known in the paint industry and can be obtained from Paul N. Gardner Company, Pompano Beach, Fla.). The Hegman Gage is a two-piece hand tool with a film casting blade used to draw an amount of the dispersion up an inclined trough. The depth of the trough indicates relative thickness areas. Readings are taken at the edge of opacity and recorded as photographs.

The photographs are examined for non-dispersed agglomerates of pigment. The fewer non-dispersed agglomerates of pigment recorded in the photograph, the better the pigment dispersion result.

### Flexibility

To evaluate the flexibility, a powder coating of the present invention is prepared with a curing agent comprising a mixture of 1,12-dodecanedioic acid and a blocked isocyanate to cure the hydroxyl functional groups in the resin. A conventional glycidyl (meth)acrylate powder is also prepared using the above curing agent mixture. The impact resistance of the coating of the present invention is evaluated and compared to the impact resistance of the conventional glycidyl (meth)acrylate powder coating as control.

The impact resistance is measured by the BYK-Gardner Impact Tester according to ASTM D2794. A greater Gardner impact (in-lbs, direct/reverse) indicates a coating with higher flexibility.

Impact resistance is also measured by conical mandrel bend tests performed by bending the coating panels on a conical mandrel tester (Gardner Laboratory, Inc., ⅛″ diameter) according to ASTM D522. Conical mandrel bend tests results are indicated as either passes or fails.

### Powder to Powder Recoatability

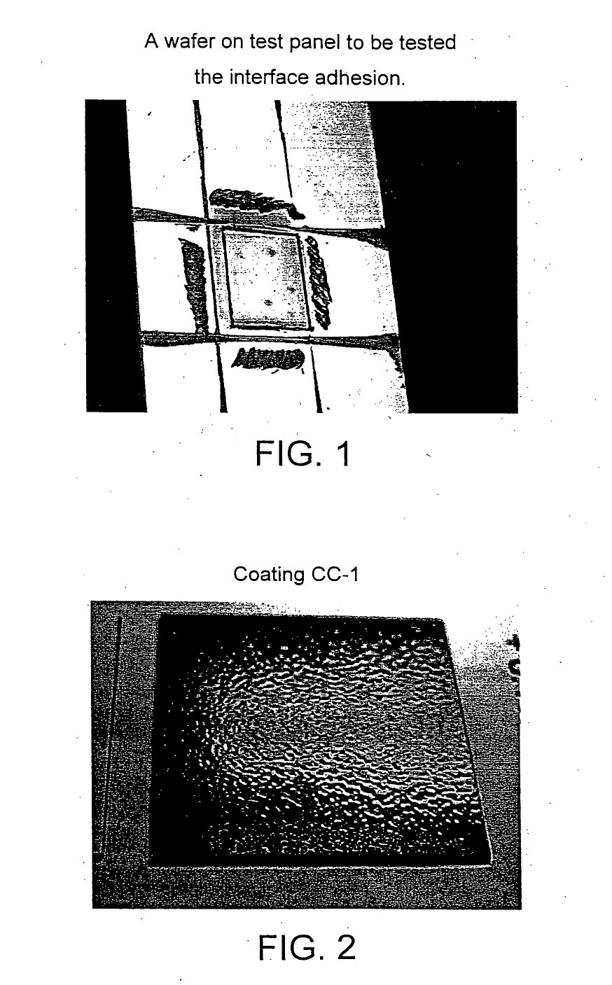

To evaluate the powder to powder recoatability, as illustrated in FIG. 1, a powder coated panel is provided. On top of the powder coated panel, a small thick wafer is prepared in a Teflon mold™ using the same powder coating composition as previously applied the panel. The wafer is shaped into 0.5×0.5 inch square. A MTS electromechanical load frame (from MTS System Corp.) is used to measure the force needed to remove the wafer from the coating surface. The test method is conducted according to a modified version of ASTM D-3165 using a 0.1 inch/minute load cell moving speed. The force needed to remove the wafer is divided by the interface area between the wafer and panel and is recorded as interface adhesion.

### EXAMPLES

The invention will be further explained by the following illustrative examples that are intended to be non-limiting.

### EXAMPLE 1

### Comparative Example—Control Resin—C1

A two gallon Parr reactor was charged with 1930 grams of xylene that was stirred at 200 rpm. Air was eliminated by consecutively pressuring and depressurizing the reactor to 60 psig with dry nitrogen four times. The mixture was heated to 139° C., after which a mixture of 450 grams of styrene, 1020 grams of methyl (meth)acrylate, 675 grams of n-butylacrylate, 855 grams of glycidyl(meth)acrylate, 3 grams of n-dodecylmercaptan and 134.1 grams oft-butylperoctoate was pumped into the reactor over 5 hours at 139° C. and autogenous pressure. The charging pump and lines were rinsed with 100 grams of xylene and the polymer solution was allowed to cool to 130° C. over 15 minutes. A mixture of 60 grams xylene and 15 grams t-butylperoctoate was added over two hours as the temperature fell from 130° C. to 100° C. The pump and lines were rinsed with 10 grams of xylene and the polymer solution held for 30 minutes at 100° C. The product solution was cooled down to 70° C. for discharging.

The product solution was then transferred to a three neck round bottom flask fitted for distillation and most of the xylene was distilled at 1 atmosphere. Vacuum was then applied while bringing the temperature up to 160° C. The molten material was stirred for 45 minutes at 167-173° C. and less than 4 mm Hg and then poured into an aluminum pan to give a friable resin with a melt index of 50 grams per 10 minutes at 125° C. under 2160 grams load, a melt viscosity of 230 poise and an epoxy equivalent weight of 520. The melt viscosity was determined in accordance with ASTM D 4287 using an ICI model VR 4752 Cone & Plate Viscometer using a 0.77 inch diameter cone operating at a shear rate of 3600 sec⁻¹. The epoxy equivalent weight was determined by the acetic acid/perchloric acid method using a Mettler Autotitrator DL25/Mettler 20 ml Buret DV920.

### EXAMPLE 2

### Resin—R1

A two gallon Parr reactor was charged 1286 grams of xylene which was stirred at 200 rpm. Air was eliminated by consecutively pressuring and depressurizing the reactor to 60 psig with dry nitrogen four times. The mixture was heated to 150° C., after which a mixture of 450 grams of styrene, 1020 grams of methyl (meth)acrylate, 336 grams of Tone M-100, 855 grams of glycidyl(meth)acrylate, and 54.0 grams of Di-t-amyl peroxide were pumped into the reactor over 4 hours at 150° C. and autogenous pressure. The charging pump and lines were rinsed with 100 grams of xylene and the polymer solution was allowed to cool to 130° C. over 15 minutes. A mixture of 60 grams xylene and 15 grams t-butylperoctoate was added over two hours as the temperature fell from 130° C. to 100° C. The pump and lines were rinsed with 10 grams of xylene and the polymer solution held for 30 minutes at 100° C. The product solution was cooled down to 70° C. for discharging.

The product solution was then transferred to a three neck round bottom flask fitted for distillation and most of the xylene was distilled at 1 atmosphere. Vacuum was then applied while bringing the temperature up to 160° C. The molten material was stirred for 45 minutes at 167-173° C. and less than 4 mm Hg and then poured into an aluminum pan to give a friable resin with a melt viscosity of 255 poise, epoxy equivalent weight of 506, and T_{g} of 45.1 ° C.

### EXAMPLE 3

### Resin—R2

A two gallon Parr reactor was charged 1286 grams of xylene that was stirred at 200 rpm. Air was eliminated by consecutively pressuring and depressurizing the reactor to 60 psig with dry nitrogen four times. The mixture was heated to 150° C., after which a mixture of 450 grams of styrene, 1260 grams of methyl (meth)acrylate, 435 grams of Tone M-200, 855 grams of glycidyl(meth)acrylate, and 54.0 grams of Di-t-amyl peroxide were pumped into the reactor over 4 hours at 150° C. and autogenous pressure. The charging pump and lines were rinsed with 100 grams of xylene and the polymer solution was allowed to cool to 130° C. over 15 minutes. A mixture of 60 grams xylene and 15 grams t-butylperoctoate was added over two hours as the temperature fell from 130° C. to 100° C. The pump and lines were rinsed with 10 grams of xylene and the polymer solution held for 30 minutes at 100° C. The product solution was then cool down to 70° C. for discharging.

The product solution was transferred to a three neck round bottom flask fitted for distillation and most of the xylene was distilled at 1 atmosphere. Vacuum was then applied while bringing the temperature up to 160° C. The molten material was stirred for 45 minutes at 167-173° C. and less than 4 mm Hg and then poured into an aluminum pan to give a friable resin with a melt viscosity of 255 poise, epoxy equivalent weight of 505, and T_{g} of 44.3° C.

### EXAMPLE 4

### Comparative Coating Example—CC1

A control clear coating composition was prepared using 289 grams of the control resin CR, 60.5 grams of 1,12-dodecanedioic acid, 1.75 grams of benzoin, 8.08 grams of Modaflow Powder III, 7 grams of Tinuvin 405, and 3.5 grams of Tinuvin 144. After premixing in a high speed food blender, this composition was melt mixed in extruder at 115° C. and 300 rpm. The cooled extrudate was ground and sieved to 170 mesh and electrostatically sprayed onto 4×12 inch zinc phosphated steel panels and cured for 30 minutes at 163° C. The resulting clear coating, having an applied thickness of 2.4-2.7 mil, exhibited the general properties summarized in Table I.

The general properties summarized in Table I were evaluated according to the following methods.

Gloss: The gloss was represented by a value (gloss at 60°) measured by a glossmeter, such as Byk-Gardner's Micro-Tri-Gloss, catalogue no. 4522.

Smoothness: evaluated wherein 1=least smooth and 10=smoothest

Pencil Hardness: Measured according to ASTM D3365.

Adhesion: crosshatch adhesion was measured according to ASTM 3359 wherein adhesion=100 indicates no loss.

DOI: Distinctness of Image was measured according to GM 91013.

Mar Resistance: A mar test was conducted by rubbing the surface of the coating using a Crockmeter (Model CM-5, made by ATLAS Electrical Devices Co.) with a powder cleanser as the rubbing media, and gloss (gloss at 60°) was evaluated before and after the rubbing. The gloss retention was calculated, and the mar resistance was a measure of the gloss retention.

Flexibility was evaluated by Gardner Impact (or impact resistance (direct/reverse)) and Mandrel Bending. Gardner Impact (direct/reverse, reported in in-lb) was measured according to ASTM D2794 by a BYK-Gardner Impact Tester. Conical mandrel bend tests were performed by bending the coating panels on a conical mandrel tester (Gardner Laboratory, Inc., ⅛ inch diameter) according to ASTM D522.

Cross-contamination was evaluated by preparing a contaminated polyester powder coating using coating composition CC1. To prepare a contaminated polyester powder coating, a polyester powder coating was blended with 0.1 % by weight coating composition CC1. This blending simulates cross-contamination which can occur in a paint shop using polyester powder coatings if GMA powder coatings are introduced. The contaminated powder coating was cured and the degree of cratering exhibited on the coating was examined. The result of the cross-contamination evaluation is shown in Table II below and FIG. 2.

The following categories were used in evaluating the contamination results:

Excellent: 0 to 2 craters per coating panel;

Good: 3 to 5 craters per coating panel;

Fair: 6 to 10 craters per coating panel; and

Severe: greater than 10 craters per coating panel.

Powder to powder recoatability was also evaluated by preparing a 1.6 mm thickness wafer on top of pre-coated (by the same powder coating) panel as shown in FIG. 1. The force to remove the wafer from the coating surface on the panel was measured by a MTS electromchanical load frame. The test was conducted according to a modified version of ASTM D-3165 using a 0.1 inch/minute load cell moving speed. The force required is defined as interface adhesion strength. The result is shown in Table III below.

### EXAMPLE 5

### Comparative Coating Example—CC2

A pigmented control coating composition was prepared using 327.6 grams of the control resin CR, 72.4 grams of 1,12-dodecanedioic acid, 4 grams of benzoin, 9.23 grams of Modaflow Powder III, 6 grams of Tinuvin 405, and 4 grams of Tinuvin 144. After premixing in a high speed food blender, this composition was melt mixed in extruder at 115° C. and 300 rpm. The cooled extrudate was ground and sieved to 170 mesh to evaluate the pigment dispersion.

The degree of pigment dispersion was evaluated by dissolving the prepared powder in toluene at 50% (by weight) concentration. The solution was then applied to Hegman Gage. Photographs were taken at various thickness areas. The results are shown below in Table IV and FIGS. 4 and 6.

### EXAMPLE 6

### Coating Example—C1

A clear coating made from R1 was prepared using 287.8 grams of the example resin R1, 62.2 grams of 1,12-dodecanedioic acid, 1.75 grams of benzoin, 8.08 grams of Modaflow Powder III, 7 grams of Tinuvin 405, and 3.5 grams of Tinuvin 144. After premixing in a high speed food blender, this composition was melt mixed in extruder at 115° C. and 300 rpm. The cooled extrudate was ground and sieved to 170 mesh and electrostatically sprayed onto 4×12 inch zinc phosphated steel panels and cured for 30 minutes at 163° C. The resulting clear coating, having an applied thickness of 2.4-2.7 mil exhibited the general properties summarized in Table I below. The general properties summarized in Table I were evaluated by carrying out the procedures as described above in Comparative COATING—CC1.

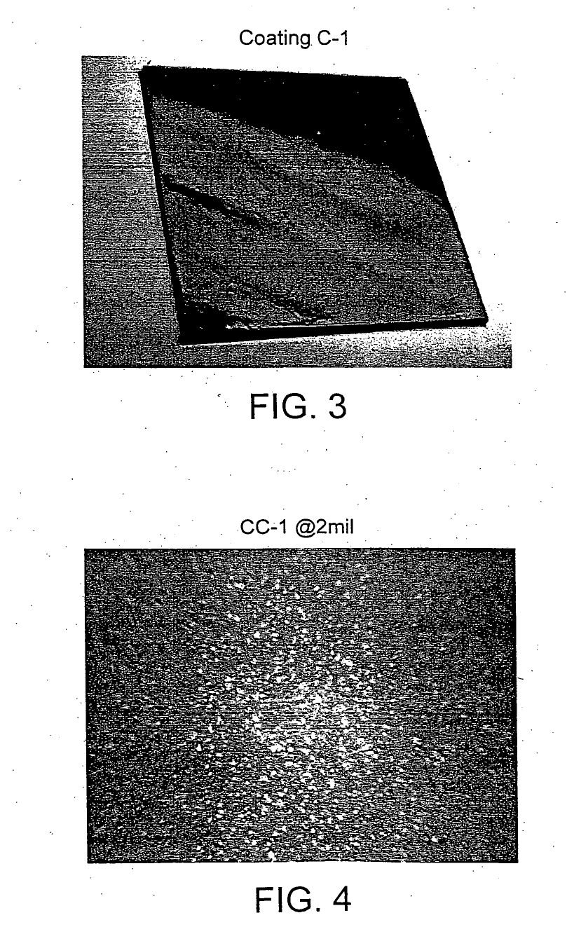

Cross-contamination was evaluated by carrying out the procedure as described above in Comparative COATING EXAMPLE—CC1. The results are shown in Table II below and FIG. 3.

### EXAMPLE 7

### Coating Example—C2

A pigmented coating was prepared from example resin R1. The pigmented coating was prepared using 325.5 grams of the example resin R1, 75.5 grams of 1,12-dodecanedioic acid, 4 grams of benzoin, 9.23 grams of Modaflow Powder III, 6 grams of Tinuvin 405, and 4 grams of Tinuvin 144. After premixing in a high speed food blender, this composition was melt mixed in extruder at 115° C. and 300 rpm. The cooled extrudate was ground and sieved to 170 mesh to evaluate the pigment dispersion.

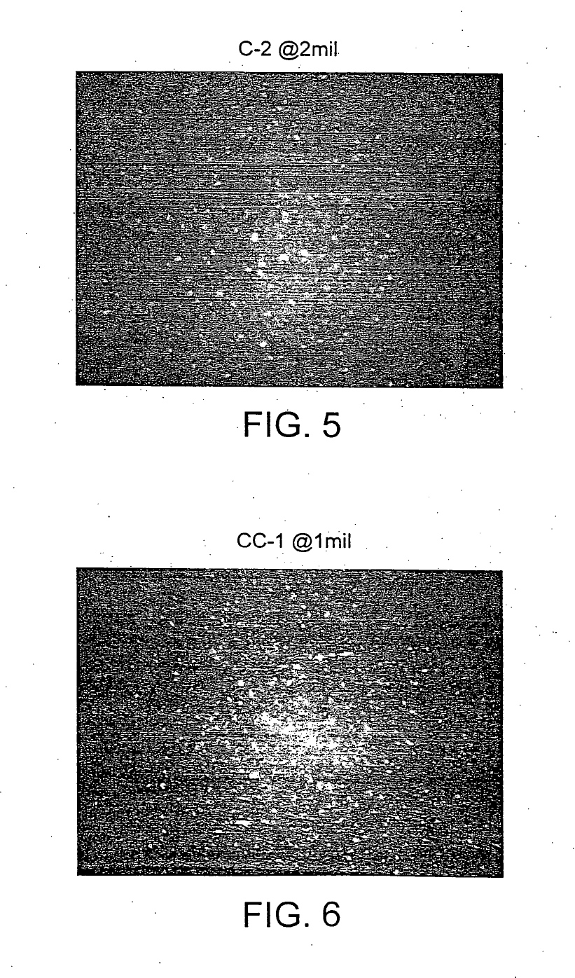

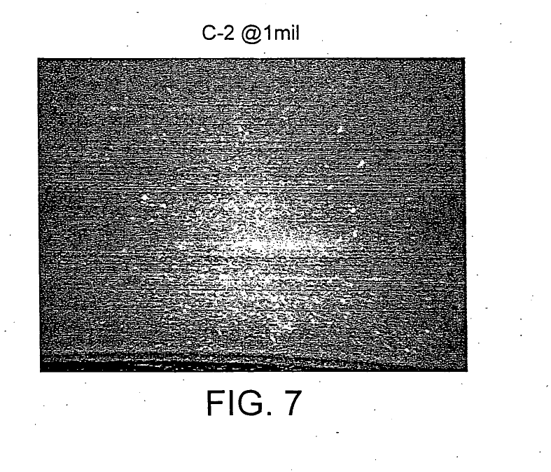

The degree of pigment dispersion was evaluated by carrying out the procedure as described above in Comparative COATING EXAMPLE—CC2. The results are shown in Table IV and FIG. 5 and 7.

### EXAMPLE 8

### Coating Example—C3

A clear coating was prepared from R2, using 261.7 grams of R2, 59.6 grams of 1,12-dodecanedioic acid, 28.8 grams of Albester 1PO55B, 1.75 grams of benzoin, 8.08 grams of Modaflow Powder III, 7 grams of Tinuvin 405, and 3.5 grams of Tinuvin 144. After premixing in a high speed food blender, this composition was melt mixed in extruder at 115° C. and 300 rpm. The cooled extrudate was ground and sieved to 170 mesh and electrostatically sprayed onto 4×12 inch zinc phosphated steel panels and cured for 30 minutes at 163° C. The resulting clear coating, having an applied thickness of 2.4-2.7 mil exhibited the general properties summarized in Table I. The general properties summarized in Table I were evaluated by carrying out the procedures as described above in Comparative COATING—CC1.

The recoatability of this powder coating was evaluated by the method as described in Comparative COATING—CC1. The results are shown in Table III.

TABLE I
General Coating Properties

| | Coating | | |
|---|---|---|---|
| | CC-1 | C-1 | C-3 |
| Gloss (60°) | 95 | 95 | 94 |
| Smoothness | 9 | 9 | 9 |
| Pencil Hardness | H- | H- | H- |
| Adhesion | 100% | 100% | 100% |
| DOI | 100 | 100 | 100 |
| Mar Resistance | 64 | 60 | 73 |
| Flexibility: | | | |
| Impact resistance (direct/reverse) | 35/<5 in-lb | 35/5 in-lb | 50/10 in-lb |
| Mandrel Bending | Fail | Pass | Pass |

TABLE II
Cross-contamination Resistance

Coating

| | CC-1 | C-1 |
|---|---|---|
| Cross-contamination | Severe cratering | Good compatibility |
| resistance | (FIG. 2) | (FIG. 3) |

TABLE III
Coating Recoatability

Coating

| | CC-1 | C-3 |
|---|---|---|
| Interface Adhesion Strength | 334 psi | 716 psi |

TABLE IV
Pigment Dispersion Property

Coating

| Image shown from Hegman Gage | CC-2 | C-2 |
|---|---|---|
| @ 2 mil | | |
| @ 1 mil | | |

Although the present invention has been described with reference to certain preferred embodiments, it is apparent that various modifications and alterations thereof may be made by those skilled in the art without departing from the scope of the invention and spirit of this invention. Other objects and advantages will become apparent to those skilled in the art from a review of the preceding description.

What is claimed is:

1. A curable powder coating composition comprising:
(a) glycidyl (meth)acrylate based resin formed by copolymerizing
(i) a glycidyl (meth)acrylate monomer of the following formula (I) 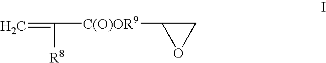
wherein R⁸ is H or a lower alkyl and R⁹ is a branched or unbranched alkyl group containing from 1 to 4 carbon atoms,
(ii) a caprolactone (meth)acrylate monomers of the following formula (II) 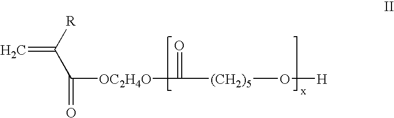
wherein x is 1 to 5 and R is hydrogen or lower alkyl, and
optionally (iii) an ethylenically unsaturated monomer other than the monomers of (i) and (ii); and
(b) a curing agent.

2. The curable powder coating composition of claim 1 further comprising the ethylenically unsaturated monomer, wherein the ethylenically unsaturated monomer is selected from the group consisting of alkyl esters of acrylic acid monomers, alkyl esters of (meth)acrylic acid monomers, vinyl monomers, and mixtures thereof.

3. The curable powder coating composition of claim 2, wherein the ethylenically unsaturated monomer is selected from the group consisting of methyl acrylate, ethyl acrylate, n-butyl acrylate, isobutyl acrylate, 2-ethylhexyl acrylate, cyclohexyl acrylate, isobornylacrylate, methyl (meth)acrylate, ethyl (meth)acrylate, n-butyl (meth)acrylate, isobutyl (meth)acrylate, 2-ethylhexyl (meth)acrylate, lauryl (meth)acrylate, tridecyl (meth)acrylate, stearyl (meth)acrylate, cyclohexyl (meth)acrylate, isobornyl (meth)acrylate, styrene, α-methyl styrene, α-ethylstyrene, vinyl toluene, divinyl benzene, vinyl chloride, vinylidene chloride, vinyl acetate, vinyl propionate, and mixtures thereof.

4. The curable powder coating composition of claim 1, wherein the glycidyl (meth)acrylate resin comprises 10 to 65 weight % glycidyl (meth)acrylate monomer and 2 to 35 weight % caprolactone (meth)acrylate monomer.

5. The curable powder coating composition of claim 1, wherein the glycidyl (meth)acrylate resin comprises 10 to 65 weight % glycidyl (meth)acrylate monomer, 2 to 30 weight % caprolactone (meth)acrylate monomer, and 5 to 88 weight % ethylenically unsaturated monomer.

6. The curable powder coating composition of claim 1, comprising 60 to 93 weight % glycidyl (meth)acrylate resin.

7. The curable powder coating composition of claim 6, comprising 7 to 40 weight % curing agent.

8. The curable powder coating composition of claim 1, wherein the glycidyl (meth)acrylate resin has a weight average molecular weight of from about 3,000 to 20,000.

9. A clearcoat prepared by curing the curable powder coating composition of claim 1.

10. The curable powder coating composition of claim 1, further comprising at least one additive.

11. The curable powder coating composition of claim 10, wherein the additive is selected from the group consisting of pigments, fillers, light stabilizers, antioxidants, curing catalysts, flow regulators, thixotropy regulators, antistatic agents, surface regulators, brighteners, anti-blocking agents, plasticizers, ultraviolet light absorbers, impact modifiers, humidity regulators, anti-caking reducers, degassers or anti-popping agents, and mixtures thereof.

12. The curable powder coating composition of claim 10, wherein the additive is selected from the group consisting of benzoin, hydroxyphenyl triazine, Modaflow®, Resiflow®, N-alkylimidazole, fumed silica, and mixtures thereof.

13. The curable powder coating composition of claim 10, wherein the pigment is added in amount from 1 to 50 percent by weight based on the total weight of the composition.

14. A curable powder coating composition comprising:
(a) glycidyl (meth)acrylate based resin formed by copolymerizing
(i) a glycidyl (meth)acrylate monomer of the following formula (I) 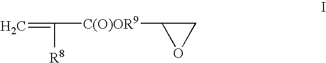
wherein R⁸ is H or a lower alkyl and R⁹ is a branched or unbranched alkyl group containing from 1 to 4 carbon atoms,
(ii) a caprolactone (meth)acrylate monomers of the following formula (II) 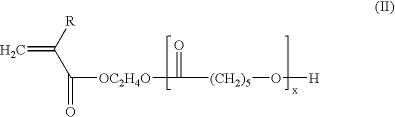
wherein x is 1 to 5 and R is hydrogen or lower alkyl, and
(iii) an ethylenically unsaturated monomer other than the monomers of (i) and (ii);
(b) a curing agent; and
(c) at least one additive selected from the group consisting of fillers, light stabilizers, antioxidants, curing catalysts, flow regulators, thixotropy regulators, antistatic agents, surface regulators, brighteners, anti-blocking agents, plasticizers, ultraviolet light absorbers, impact modifiers, humidity regulators, anti-caking reducers, degassers or anti-popping agents, and mixtures thereof.

15. The curable powder coating composition of claim 14, comprising 60 to 93 weight % glycidyl (meth)acrylate resin.

16. The curable powder coating composition of claim 14, wherein the glycidyl (meth)acrylate resin has a weight average molecular weight of from about 3,000 to 20,000.

17. The curable powder coating composition of claim 14, wherein the ethylenically unsaturated monomer is selected from the group consisting of methyl acrylate, ethyl acrylate, n-butyl acrylate, isobutyl acrylate, 2-ethylhexyl acrylate, cyclohexyl acrylate, isobornylacrylate, methyl (meth)acrylate, ethyl (meth)acrylate, n-butyl (meth)acrylate, isobutyl (meth)acrylate, 2-ethylhexyl (meth)acrylate, lauryl (meth)acrylate, tridecyl (meth)acrylate, stearyl (meth)acrylate, cyclohexyl (meth)acrylate, isobornyl (meth)acrylate, styrene, α-methyl styrene, α-ethylstyrene, vinyl toluene, divinyl benzene, vinyl chloride, vinylidene chloride, vinyl acetate, vinyl propionate, and mixtures thereof.

18. A clearcoat prepared by curing the curable powder coating composition of claim 14.

19. A curable powder coating composition comprising:
(a) glycidyl (meth)acrylate based resin formed by copolymerizing
(i) a glycidyl (meth)acrylate monomer of the following formula (I) 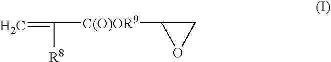
wherein R⁸ is H or a lower alkyl and R⁹ is a branched or unbranched alkyl group containing from 1 to 4 carbon atoms,
(ii) a caprolactone (meth)acrylate monomers of the following formula (II) 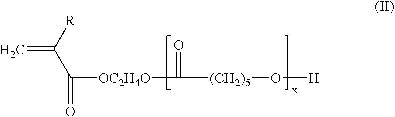
wherein x is 1 to 5 and R is hydrogen or lower alkyl, and
(iii) an ethylenically unsaturated monomer other than the monomers of (i) and (ii);
(b) a curing agent; and
(c) at least one additive selected from the group consisting of benzoin, hydroxyphenyl triazine, Modaflow®, Resiflow®, N-alkylimidazole, fumed silica, and mixtures thereof.

20. A clearcoat prepared by curing the curable powder coating composition of claim 19.
